(19) United States
(12) Patent Application Publication
(10) Pub. No.: US 2025/0189330 A1
(43) Pub. Date: Jun. 12, 2025

(54) ROAD TRIP STOPOVER RECOMMENDATION METHOD CONSIDERING TRAVEL TIME AND NAVIGATION SYSTEM PERFORMING THE SAME

(71) Applicant: HYUNDAI AUTOEVER CORP., Seoul (KR)

(72) Inventors: Yeon Su KIM, Seoul (KR); Moon Jeong KIM, Seoul (KR); So Jung KIM, Seoul (KR); Suk Ho LEE, Seoul (KR); Won Mi AHN, Seoul (KR); Hwa Hyeon HONG, Seoul (KR)

(21) Appl. No.: 18/960,895

(22) Filed: Nov. 26, 2024

(30) Foreign Application Priority Data
Dec. 7, 2023 (KR) 10-2023-0176265

(51) Int. Cl. G01C 21/34; G01C 21/36; G06Q 30/0601

(52) U.S. Cl. CPC G01C 21/3484; G01C 21/3461; G01C 21/3492; G01C 21/3679; G06Q 30/0639

(57) ABSTRACT

Road trip stopover recommendation methods and devices are described. According to one embodiment, a method comprises calculating a time required to reach a destination set by a user, determining whether the time exceeds a threshold time, wherein the threshold time is an average of longest daily driving times among driving records of a plurality of users, proposing a road trip mode based on the time, a vehicle information, a traffic information and a weather information when the time exceeds the threshold time, setting a route based on the vehicle information, the traffic information and the weather information when the user decides to switch to the road trip mode, recommending a stopover on the set route based on the vehicle information, the traffic information and the weather information, displaying a detailed information on the set route and the stopover, and determining a route including the stopover as a final route.

### CROSS-REFERENCE TO RELATED APPLICATION

This application claims priority from Korean Patent Application No. 10-2023-0176265 filed on Dec. 7, 2023 in the Korean Intellectual Property Office and all the benefits accruing therefrom under 35 U.S.C. 119, the contents of which in its entirety are herein incorporated by reference.

### BACKGROUND

### Technical Field

The present disclosure relates to a road trip stopover recommendation method and a navigation system performing the same, and more particularly, to a stopover recommendation method for switching to a road trip mode in consideration of a travel time required to reach a destination set by a user, and providing an advanced route based on vehicle information, traffic information and weather information in the road trip mode.

### Description of the Related Art

In general, a navigation system equipped with a Global Positioning System (GPS) to check a current position and a moving speed of a corresponding mobile object or determine the moving speed has been used in various mobility devices. The navigation system receives radio waves representing latitude, longitude and altitude from multiple satellites and computes the current position of the mobile object to confirm the current position of the mobile object, confirms a destination input from a user, and determines a moving route from the current position to the destination.

The navigation system determines a route by reflecting various kinds of information related to driving, such as a distance to a destination, the arrival time to the destination and the cost to the destination, including an optimal distance to the destination, a shortest distance to the destination, traffic conditions and the use of free or toll roads. In addition to receiving the destination directly input from the user, the navigation system also includes a component that may search for the current position or the surroundings of the destination, and a component that recommends a stopover.

The navigation system does not simply perform a function of providing a shortest route for a user to arrive at a destination. In particular, in an area where driving exceeds one day, a road trip in which a car travels for more than one week to 15 days is established as a travel culture. It is known that many users use a vehicle navigation system rather than a mobile navigation system because they often pass through an area where communication is not available during a road trip. Therefore, a road trip stopover recommendation method of a navigation system that enables a road trip user to have a more advanced experience will be required.

### BRIEF SUMMARY

An object of the present disclosure is to provide a road trip stopover recommendation method of proposing a road trip mode to a user in consideration of the time required to reach a destination set by a user, vehicle information, traffic information and weather information, setting a route to the destination in the road trip mode, and recommending a stopover on the set route in accordance with the vehicle information, the traffic information and the weather information.

The objects of the present disclosure are not limited to those mentioned above and additional objects of the present disclosure, which are not mentioned herein, will be clearly understood by those skilled in the art from the following description of the present disclosure.

According to an aspect of the present disclosure, a computing device may comprise a processor; and a memory storing instructions, wherein the instructions, when executed by the processor, may allow the processor to perform calculating the time required to reach a destination set by a user; determining whether the calculated time exceeds a predetermined threshold time, the threshold time being determined as an average of the longest daily driving time among driving records of a plurality of users, which are stored in an external server; proposing a road trip mode based on the calculated time, vehicle information indicating a state of a vehicle, external traffic information and weather information when the calculated time exceeds the threshold time; setting a route based on the vehicle information, the traffic information and the weather information when the user decides to switch to the road trip mode; recommending a stopover on the set route based on the vehicle information, the traffic information and the weather information; displaying detailed information on the set route and the recommended stopover; and determining a route including the recommended stopover as a final route in response to the user's approval for the recommended stopover.

In one embodiment, the vehicle information may include at least one of vehicle position (GPS) information, whether a child lock is activated, whether a seat belt is fastened, media information in play, Carpay payment details, distance to empty (DTE) information indicating a fuel charge amount, whether a wiper is operated, load weight, or past destination setting details.

In one embodiment, the traffic information may include information on accident and control sections, assembly and event information, and the traffic information and the weather information may be acquired from an external server.

In one embodiment, the setting a route may include: determining whether a child lock is turned on; determining that a child rides in the vehicle when the child lock is turned on; and setting the route so that a daily driving distance is less than a predetermined threshold distance, the threshold distance being determined as a maximum driving distance when a child rides, among the user's driving records.

In one embodiment, the setting a route may include: acquiring an average daily driving time and a maximum driving time continuous without stop from the user's driving records; and setting the route so that a total driving time does not exceed the average driving time and the stopover is located within the maximum driving time.

In one embodiment, the setting a route may include: determining a section, which is not to be driven, based on the traffic information or the weather information; and setting the route by excluding the determined section.

In one embodiment, the setting a route may include: acquiring driving routes of other users with the same driving pattern or the same type of passenger as the corresponding user; and setting the route to one of the acquired driving routes of other users.

In one embodiment, the recommending a stopover on the set route may include: determining whether seatbelts in seats other than a driver's seat are fastened; identifying the number of passengers through the number of seat belts fastened when the seat belts in seats other than the driver's seat are fastened; and recommending a place, which may be used by the number of identified passengers on the set route, as the stopover.

In one embodiment, the recommending a stopover on the set route may include: identifying an age group of a passenger through media information in play; and recommending a place corresponding to a category preferred by the age group of the passenger as the stopover on the set route.

In one embodiment, the recommending a stopover on the set route may include: determining whether a child lock is turned on; determining that a child rides in the vehicle when the child lock is turned on; and recommending a place related to a child or a place where child access is possible on the set route as the stopover.

In one embodiment, the recommending a stopover on the set route may include: identifying a category preferred by the user through past destination setting details; and recommending a place corresponding to the preferred category on the set route as the stopover.

In one embodiment, the recommending a stopover on the set route may include: identifying a product preferred by the user through Carpay payment details; and recommending a place related to the preferred product on the set route as the stopover.

In one embodiment, the recommending a stopover on the set route may include: determining whether a wiper is operating for more than a predetermined threshold time; and recommending an indoor stopover on the set route by determining that it is raining when the wiper is operating for more than the threshold time.

In one embodiment, the recommending a stopover on the set route may include: determining whether there is a camping site in the user's past destination setting details; determining whether a weight of luggage loaded in the vehicle is greater than or equal to a predetermined threshold value when there is a camping site in the past destination setting details; and recommending the camping site on the set route as the stopover when the weight of the loaded luggage is greater than or equal to the threshold value.

In one embodiment, the recommending a stopover on the set route may include: determining whether a distance to empty (DTE) is less than a predetermined threshold value, the threshold value being determined based on the amount of fuel required to drive a daily driving distance; and recommending a gas station or a charging station on the set route as the stopover when the DTE is less than the threshold value.

According to another aspect of the present disclosure, a road trip stopover recommendation method may be performed by a computing device, and the method may comprise: calculating the time required to reach a destination set by a user; determining whether the calculated time exceeds a predetermined threshold time, the threshold time being determined as an average of the longest daily driving time among driving records of a plurality of users, which are stored in an external server; proposing a road trip mode based on the calculated time, vehicle information indicating a state of a vehicle, external traffic information and weather information when the calculated time exceeds the threshold time; setting a route based on the vehicle information, the traffic information and the weather information when the user decides to switch to the road trip mode; recommending a stopover on the set route based on the vehicle information, the traffic information and the weather information; displaying detailed information on the set route and the recommended stopover; and determining a route including the recommended stopover as a final route in response to the user's approval for the recommended stopover.

In one embodiment, the vehicle information may include at least one of vehicle position (GPS) information, whether a child lock is activated, whether a seat belt is fastened, media information in play, Carpay payment details, distance to empty (DTE) information indicating a fuel charge amount, whether a wiper is operated, load weight, or past destination setting details.

In one embodiment, the setting a route may include: acquiring an average daily driving time and a maximum driving time continuous without stop from the user's driving records; and setting the route so that a total driving time does not exceed the average driving time and the stopover is located within the maximum driving time.

In one embodiment, the recommending a stopover on the set route may include: determining whether seatbelts in seats other than a driver's seat are fastened; identifying the number of passengers through the number of seat belts fastened when the seat belts in seats other than the driver's seat are fastened; and recommending a place, which may be used by the number of identified passengers on the set route, as the stopover.

In one embodiment, the recommending a stopover on the set route may include: determining whether a child lock is turned on; determining that a child rides in the vehicle when the child lock is turned on; and recommending a place related to a child or a place where child access is possible on the set route as the stopover.

### BRIEF DESCRIPTION OF THE DRAWINGS

The above and other aspects and features of the present disclosure will become more apparent by describing in detail exemplary embodiments thereof with reference to the attached drawings, in which:

FIG. 1 exemplarily illustrates an environment to which a navigation system for performing a road trip stopover recommendation method according to the embodiment of the present disclosure may be applied;

FIG. 2 exemplarily illustrates an initial screen of a navigation system of FIG. 1;

FIG. 3 exemplarily illustrates a route search screen of a navigation system of FIG. 1;

FIG. 4 exemplarily illustrates a route guide screen according to a road trip mode of a navigation system of FIG. 1;

FIG. 5 is a flow chart illustrating a road trip stopover recommendation method according to the embodiment of the present disclosure;

FIGS. 6 to 9 are flow charts illustrating embodiments of a step of setting a route based on vehicle information and external information of FIG. 5 in detail;

FIGS. 10 to 17 are flow charts illustrating embodiments of a step of recommending a stopover on a set route of FIG. 5 in detail; and

FIG. 18 is a block diagram illustrating a hardware configuration of a computing device for recommending a road trip stopover according to the embodiment of the present disclosure.

### DETAILED DESCRIPTION OF THE DISCLOSURE

Preferred embodiments of the present disclosure will hereinafter be described in detail with reference to the accompanying drawings. The advantages, features, and methods of achieving them of the present disclosure will become clearer with the embodiments described in detail along with the accompanying drawings. However, the present disclosure is not limited to the embodiments described below and can be implemented in various different forms. These embodiments are provided only to make the disclosure complete and fully inform those of ordinary skill in the technical field to which the present disclosure belongs, and the present disclosure is defined only by the scope of the claims.

It is noted that the same reference numerals are used for the same elements across different drawings as far as possible. Furthermore, in describing the present disclosure, detailed descriptions of known configurations or functions will be omitted when they may obscure the essence of the present disclosure.

Unless defined otherwise, all terms used herein (including technical and scientific terms) can have the meaning commonly understood by one of ordinary skill in the art to which the present disclosure belongs. Terms defined in commonly used dictionaries are not interpreted in an ideal or excessive manner unless explicitly defined otherwise. The terms used in the present specification are for the purpose of describing particular embodiments only and are not intended to limit the invention. In this specification, the singular forms include plural forms unless the context clearly indicates otherwise.

Furthermore, in describing the components of the present disclosure, terms such as first, second, A, B, (a), (b), etc., may be used. These terms are intended to distinguish the components from others, and the essence, order, or sequence of such components is not limited by these terms. If a component is stated as being “connected,” “coupled,” or “linked” to another component, the component can be directly connected or linked to the other component, but it should be understood that there may also exist other components “connected,” “coupled,” or “linked between them.

The terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

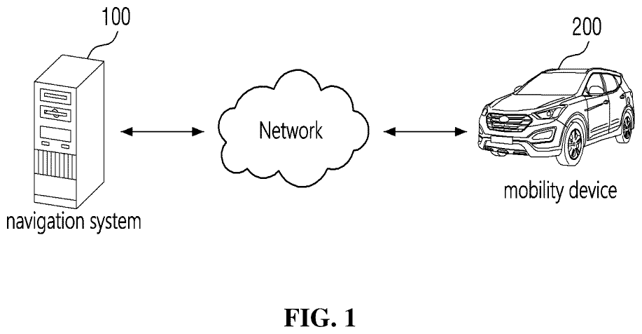

FIG. 1 exemplarily illustrates an environment to which a navigation system 100 for performing a road trip stopover recommendation method according to the embodiment of the present disclosure may be applied. Hereinafter, for convenience of description, it is assumed that a mobility device 200 is a vehicle, and in this case, the same reference numeral will be given to the mobility device 200 and the vehicle 200, but the present disclosure is not limited thereto. The mobility device 200 may be also implemented as another type of transportation means other than the vehicle. In addition, in the present disclosure, a user represents a driver of the mobility device 200.

The navigation system 100 may first calculate a time required to reach a destination set by the user, acquire vehicle information indicating a state of the vehicle through communication with the mobility device 200 and acquire traffic information (e.g., information on an accident and a control section, and information on assembly and event) and weather information from an external server. For example, the traffic information and the weather information may be stored in an arbitrary server and provided to the navigation system 100 through a network. Afterwards, the navigation system 100 may propose a road trip mode to the user based on the calculated time required, the vehicle information, the external traffic information and the weather information.

In detail, prior to proposing the road trip mode, it may be determined whether the calculated time required exceeds a predetermined threshold time. For example, the threshold time may be determined as an average of the longest daily driving time among driving records of a plurality of users, which are stored in the external server. When the calculated time required is less than the threshold time, the road trip mode may not be proposed. On the other hand, when the calculated time required exceeds the threshold time, it may be additionally determined whether or not the arrival within one day is possible in consideration of the vehicle information, the traffic information and the weather information. For example, when a child or an elderly person rides in a vehicle, when traffic congestion is expected, and when it is expected to snow or rain, a daily driving distance may be shortened, and a longer time may be taken than the calculated time required, whereby it may be determined that the arrival within one day is not possible. In this way, when it is determined that the arrival to the destination within one day is not possible and needs to be driven for more than two days, the navigation system 100 may suggest a user to switch to the road trip mode.

When the user decides to switch to the road trip mode, the navigation system 100 may set a road trip route for more than two days based on the vehicle information, the external traffic information and the weather information. For example, the information indicating the state of the vehicle 200 may include vehicle position (GPS) information, whether a child lock is activated, whether a seat belt is fastened, whether a charger is used, seat weight information, media information in play, Carpay payment details, distance to empty (DTE) information indicating a fuel charge amount, whether a warning signal is received, whether a washer liquid is used, whether a wiper is operated, whether a sunroof is opened or closed, load weight, past destination setting details, and the like.

It is possible to determine whether a child has been accompanied through whether the child lock is activated, and to determine the number of passengers through whether seat belts are fastened. In addition, it is possible to identify an age group of the passengers through the media information in play (for example, it can be determined that a child has been accompanied while a children's song is being played, and an elderly person rides in a vehicle when a trot is being played). It is possible to identify whether refueling or charging is necessary, through the DTE information, and to identify the weather through the the wiper. Furthermore, it is possible to identify a category of a place preferred by the user through the past destination setting details.

For example, based on the traffic information and the weather information, the navigation system 100 may set a route not to pass a specific road or place depending on whether traffic congestion is expected at a specific point or whether it is expected to rain or snow. In addition, when there is a child or an elderly person among the passengers, the navigation system 100 may adjust a maximum driving distance or driving time per day not to exceed a predetermined distance or predetermined time. In addition, the navigation system 100 may receive information on a driving route of users (e.g., users belonging to a similar age group, a similar driving pattern, a similar category of a preferred place, or a similar passenger type) who have personal information similar to the corresponding user from an external server through a network, and may recommend the information to the user.

The navigation system 100 may recommend the stopover on the road trip route set in this way for each day. Furthermore, the navigation system 100 according to the embodiment of the present disclosure may recommend the stopover by additionally utilizing the current time, traffic information, weather information, information on a specific place (e.g., population density information of a city or destination where the vehicle is currently located), in addition to the information indicating the state of the vehicle 200 described above. For example, the recommended stopover may include all of a restaurant, a cafe, an accommodation, a scenic road, a tourist attraction spot, a parking lot, a gas station, a charging station, and the like.

For example, when it is determined that a child rides in the vehicle, the navigation system 100 may recommend a stopover for a place related to a child (e.g., a kids cafe, an amusement park, etc.) on a set route, and may not recommend a place where children are not allowed to enter (so-called no-kids zone) as a stopover. When it is determined through the DTE information that refueling or charging is required, the navigation system 100 may recommend a gas station/charging station on the route as a stopover, and when the wiper continues to operate, it may be considered to be raining and recommended mainly for an indoor stopover. In addition, when the number of passengers is identified through whether the seat belts are fastened and when recommending the accommodation, the restaurant, the cafe, etc. on the set route as a stopover, the identified number of passengers may be considered. That is, the context related to the user and the passenger may be identified through the vehicle information acquired from the inside of the vehicle.

The navigation system 100 may display detailed information on the set route and the recommended stopover. For example, the detailed information may include a total length of the route, a total time required, a daily driving distance, a daily recommended stopover, and an expected arrival time and stay time for each stopover. The user of the vehicle may confirm the detailed information on the set route and the recommended stopover, which are displayed on the navigation system 100 as described above, and then may determine the route including the stopover as a final route.

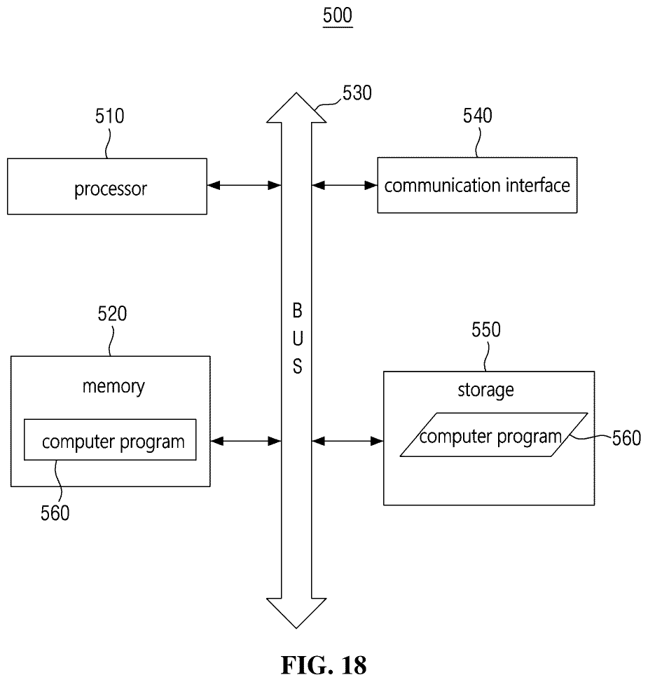

The navigation system 100 according to the embodiment of the present disclosure may be implemented on at least one computing device. For example, all functions of the navigation system 100 may be implemented in a single computing device, some functions of the navigation system 100 may be implemented in a first computing device, and other functions may be implemented in a second computing device. Alternatively, a specific function of the navigation system 100 may be implemented in a plurality of computing devices. For example, a stopover recommendation function of the navigation system 100 and a function for displaying information on a destination may be implemented separately from different computing devices. The computing device may include an arbitrary device provided with a computing means and a communication means, and the embodiment in which the navigation system 100 is implemented as a computing device will be described in more detail with reference to FIG. 18.

Furthermore, the components shown in FIG. 1 may perform communication with each other through a network. For example, the network may be implemented as any type of wired/wireless network such as a local area network (LAN), a wide area network (WAN), a mobile radio communication network and a wireless broadband Internet (Wibro).

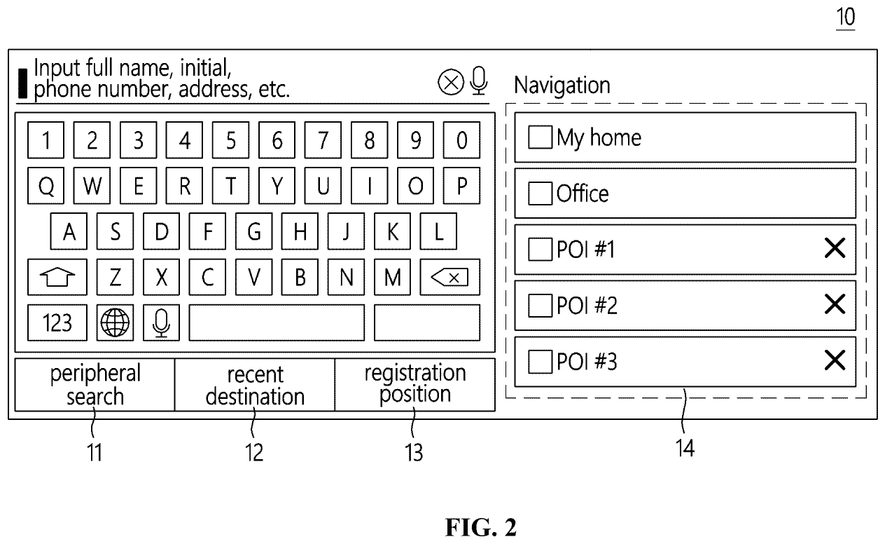

Hereinafter, a user interface of the navigation system 100 supporting the road trip mode will be described with reference to FIGS. 2 to 4.

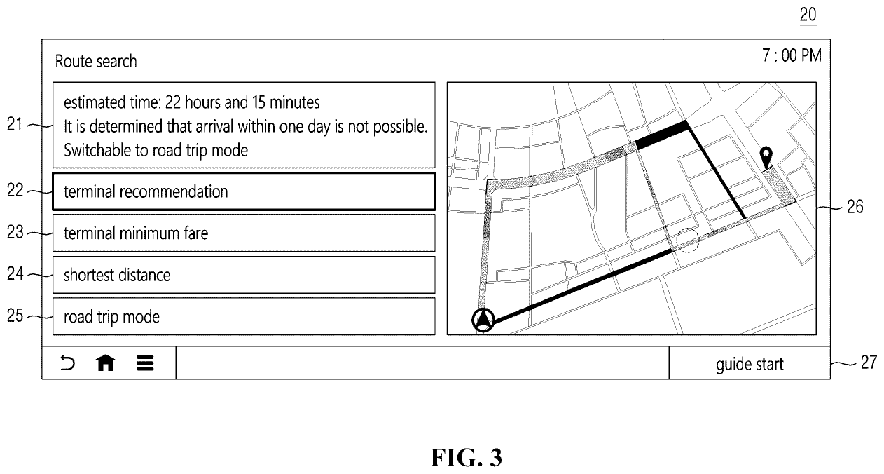

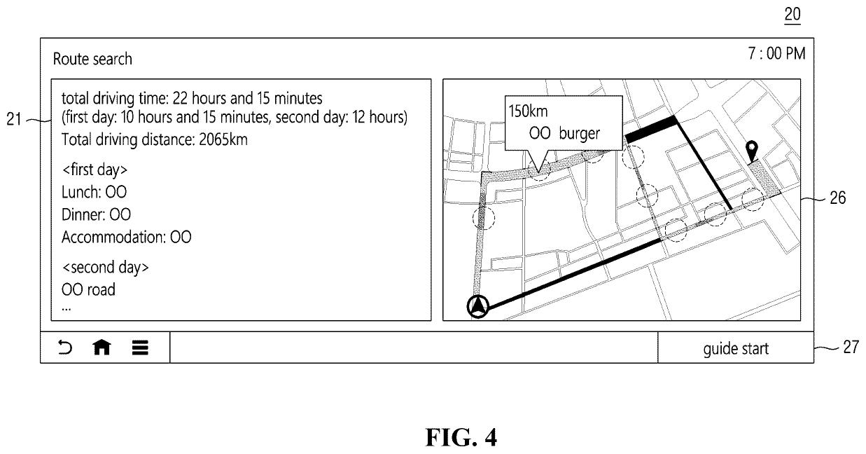

FIG. 2 exemplarily illustrates an initial screen 10 of a navigation system 100 of FIG. 1. Referring to FIG. 2, the navigation system 100 may receive a search word from a user of the mobility device 200, may search for a route to one or more destinations corresponding to the received search word, guide the searched route and display information related to the destination on a screen. Referring to FIG. 2, a peripheral search button 11, a recent destination button 12 and a registration position button 13 are shown on an initial screen 10. When the peripheral search button 11 is pressed, search categories around a current position, around a destination, around a route, or around an area may be displayed. When the recent destination button 12 is pressed, destinations corresponding to recently received search words may be displayed, and when the registration position button 13 is pressed, destinations with a high search frequency (e.g., home, office, etc.) may be displayed. For example, the positions 14 displayed on a right side of the initial screen 10 shown in FIG. 2 may be lists of registered destinations. Hereinafter, a route guide screen and a road trip mode, which are displayed after inputting a search word or selecting a registered destination, will be described with reference to FIGS. 3 to 4.

FIG. 3 exemplarily illustrates a route search screen 20 of the navigation system 100 of FIG. 1. Referring to FIG. 3, a description 21 of a route, suggested routes 22, 23 and 24, a map 26 and a guide start button 27 are shown. The suggested routes include a terminal recommendation route 22, a terminal minimum fare route 23, and a shortest distance route 24, and the description 21 of the route may include an estimated time required, whether arrival is possible within a day, and a guide that may be switched to the road trip mode when the road trip mode is proposed by the navigation system 100.

Referring to FIG. 3, the terminal recommended route 22 is currently selected, and a message indicating that the arrival within one day is determined not to be possible together with an estimated time (22 hours and 15 minutes) and that a route search mode may be switched to the road trip mode is shown. The same type of information will be displayed for the terminal minimum fare route 23 and the shortest distance route 24. When the road trip mode is proposed as shown in FIG. 3, the route search mode of the navigation system 100 may be switched to the road trip mode through a road trip mode button 25. A selected route is displayed on the map 26, and when the guide start button 27 is pressed, the navigation system 100 may start driving guide in accordance with the selected route. Hereinafter, the embodiment in which the road trip mode button 25 is selected on the route search screen 20 will be described with reference to FIG. 4.

FIG. 4 exemplarily illustrates a route guide screen 20 according to a road trip mode of the navigation system 100 of FIG. 1. Referring to FIG. 4, detailed information related to a road trip route and recommended stopovers, which are set in the description 21 of the route, may be shown. For example, the detailed information may include a total driving time of the road trip route, a daily driving time, a total driving distance, and a recommended stopover and visit order for each day. In addition, the selected route and stopovers may be reflected on the map 26. When the user decides to select the route including the recommended stopover as a final road trip route, the user may receive the guidance on the final road trip route through the guide start button 27.

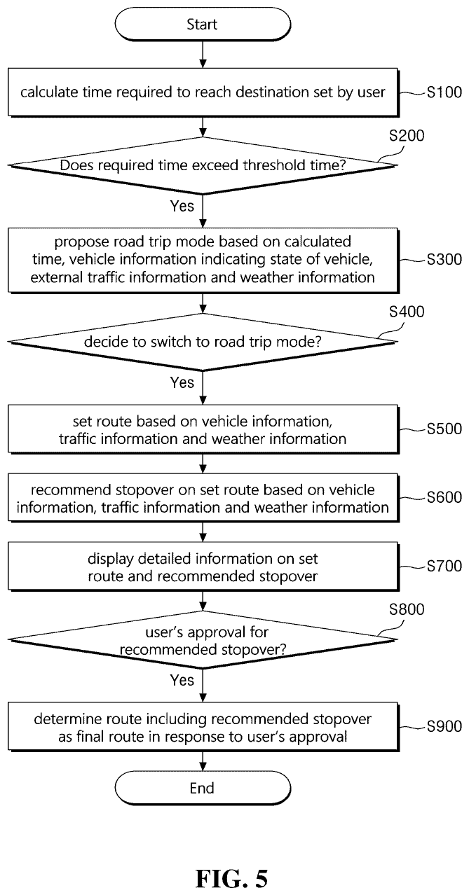

FIG. 5 is a flow chart illustrating a road trip stopover recommendation method according to the embodiment of the present disclosure. For reference, FIG. 5 illustrates steps/operations performed by the navigation system 100 of FIG. 1. Therefore, in the following descriptions, when a subject of a specific step/operation is omitted, it may be understood that the corresponding step/operation is performed by the navigation system 100 of FIG. 1. In addition, it is assumed that the mobility device 200 of FIG. 1 is a vehicle as described with reference to FIG. 1, but the present disclosure is not limited thereto, and embodiments described below may be applied to all mobility devices 200 other than the vehicle. Hereinafter, the description will be made with reference to FIGS. 1 to 4 together with FIG. 1.

In step S100, the time required to reach a destination set by a user may be calculated. Also, in step S200, it may be determined whether the calculated time required exceeds a predetermined threshold time. For example, the threshold time may be determined as an average of the longest driving time among driving records of a plurality of users, which are stored in the external server.

When the time required exceeds the threshold time (YES), in step S300, a road trip mode may be proposed based on the calculated time, vehicle information indicating a state of the vehicle, external traffic information, and weather information. For example, the vehicle information may include vehicle position (GPS) information, whether a child lock is activated, whether a seat belt is fastened, whether a charger is used, seat weight information, media information in play, Carpay payment details, distance to empty (DTE) information indicating a fuel charge amount, whether a warning signal is received, whether a washer liquid is used, whether a wiper is operated, whether a sunroof is opened or closed, load weight, past destination setting details, and the like. Furthermore, the external information may include traffic information (e.g., information on an accident and control section, and information on assembly and event) and weather information, which may be acquired from an external server.

In step S400, it may be determined whether the user has decided to switch to the road trip mode. In the case that the user has decided to switch to the road trip mode (YES), in step S500, a route may be set based on vehicle information, traffic information and weather information. For example, the route may be set so as not to pass a specific road or place depending on whether traffic congestion is expected at a specific point or whether it is expected to snow or rain. Also, when a child or an elderly person among passengers rides in a vehicle, a maximum driving distance or a driving time per day may be adjusted not to exceed a predetermined distance or a predetermined time.

In step S600, a stopover on the route set based on the vehicle information, the traffic information and the weather information may be recommended. Various contexts related to the user and the passenger may be acquired through the above-described vehicle information, and a stopover related to the acquired context may be recommended. For example, when it is determined that a child is accompanied, the navigation system 100 may recommend a stopover for a place related to a child (e.g., a kids cafe, an amusement park, etc.) on the set route, and may not recommend a place where children are not allowed to enter (so-called no-kids zone) as a stopover.

In step S700, detailed information on the set route and the recommended stopover may be displayed. For example, the detailed information may include a total length of the route, a total time required, a daily driving distance, a daily recommended stopover, and an expected arrival time and stay time for each stopover. In step S800, it may be determined whether the user approves the recommended stopover. For example, the user may approve the stopover by checking the recommended road trip route and the recommended stopover on the screen as shown in FIG. 4 and then pressing a guide start button. When the recommended stopover is approved by the user (YES), in step S900, a route including the recommended stopover may be determined as a final route in response to the user's approval. Meanwhile, when the recommended stopover is not approved by the user (NO), a new stopover may be recommended by returning to step S600.

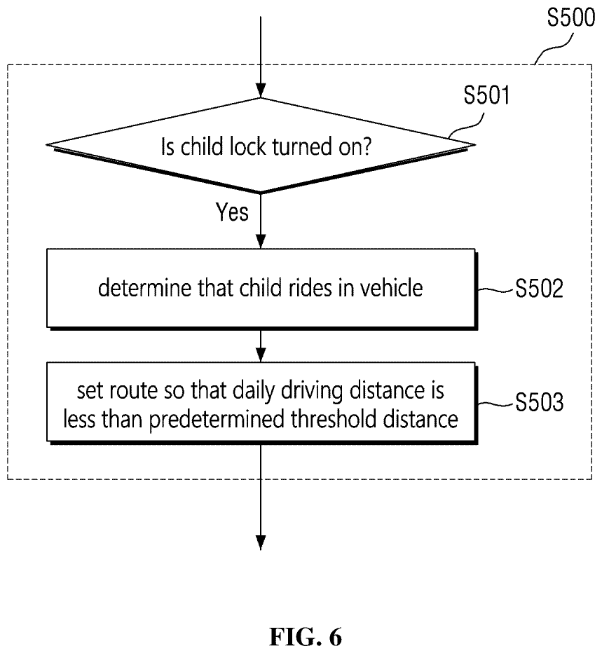

Hereinafter, various embodiments related to step S500 will be described with reference to FIGS. 6 to 9. FIGS. 6 to 9 are flow charts illustrating embodiments of a step S500 of setting a route based on vehicle information and external information of FIG. 5 in detail.

Referring to FIG. 6, in step S501, it may be determined whether a child lock is turned on. When the child lock is turned on (YES), in step S511, it may be determined that a child rides in the vehicle, and in step S503, the route may be set so that a daily driving distance is less than a predetermined threshold distance. For example, the threshold distance may be determined as a maximum driving distance when a child rides in the vehicle, among the driving records of the user. That is, whether a passenger is present and a passenger type may be identified through the embodiment shown in FIG. 6, and thus, the daily driving distance may be determined, and a road trip route, in which the set daily driving distance is reflected, may be set. Although FIG. 6 illustrates the embodiment of a case that a child rides in a vehicle, the case that an elderly person rides in a vehicle will be similar thereto.

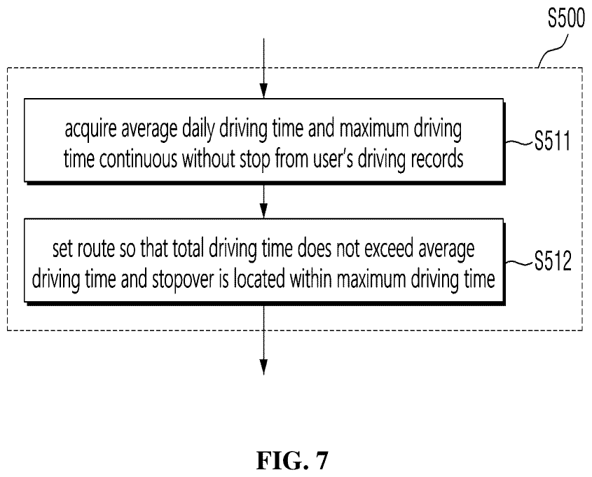

Referring to FIG. 7, in step S511, an average daily driving time and a maximum driving time continuously driven without stop may be acquired from the driving records of the user. Afterwards, in step S512, the route may be set so that the total driving time does not exceed the acquired average driving time and the stopover is located within the maximum driving time continuously driven without stop. In other words, the route may be set so that a road where no stopover is located within the maximum driving time may not be driven. That is, through the embodiment shown in FIG. 7, a driving time and a route of a day may be provided in a road trip in accordance with the user's usual driving time.

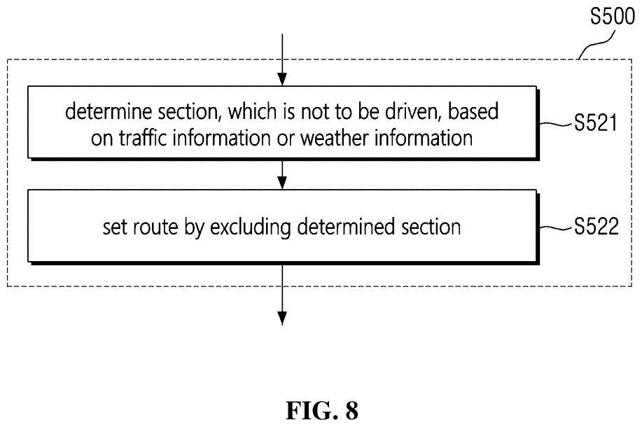

Referring to FIG. 8, in step S521, a section not to be driven may be determined based on the traffic information or the weather information. For example, a road that is likely to be flooded when it rains may be determined as a section not to be driven, and a road passing through a specific section that is expected to be in traffic congestion may be determined as a section not to be driven. In step S522, a route may be set by excluding the determined section. That is, a road trip route in which traffic information and weather information are considered may be set through the embodiment shown in FIG. 8.

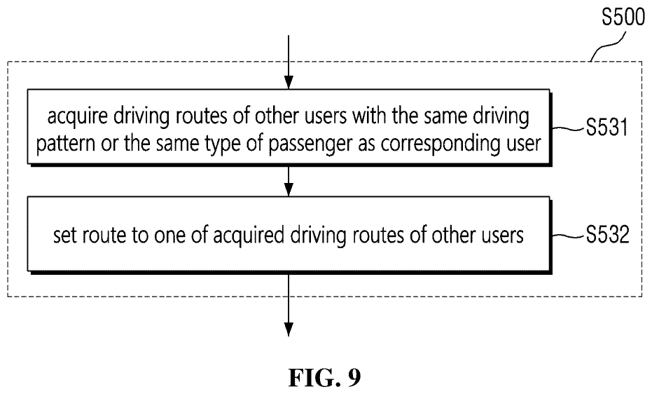

Referring to FIG. 9, in step S531, a driving route of other users having similar personal information to the corresponding user may be acquired. For example, the personal information of other users may be stored as big data in the external server, and the case that other users have similar personal information to the corresponding user may include a case that a driving pattern or the type of the passenger is the same between them. In step S532, a route may be set to one of the acquired driving routes of other users. That is, the driving route of other users having a driving pattern similar to that of the corresponding user may be recommended.

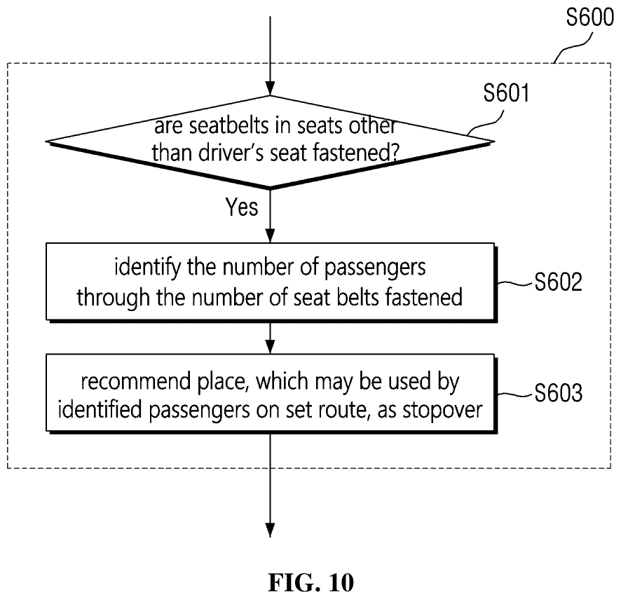

Hereinafter, various embodiments related to step S600 will be described with reference to FIGS. 10 to 17. FIGS. 10 to 17 are flow charts illustrating embodiments of a step 600 of recommending a stopover on a set route of FIG. 5 in detail.

Referring to FIG. 10, in step S601, it may be determined whether seat belts for seats other than a driver's seat are fastened. When the seat belts are fastened (YES), in step S602, the number of passengers may be identified through the number of fastened seat belts. Afterwards, in step S603, a place that may be used by the number of people identified on the set route may be recommended as a stopover. For example, in case of a restaurant, whether the identified number of people may eat at once may be considered, and in case of accommodation, whether a reservation is possible as many as the identified number of people may be considered.

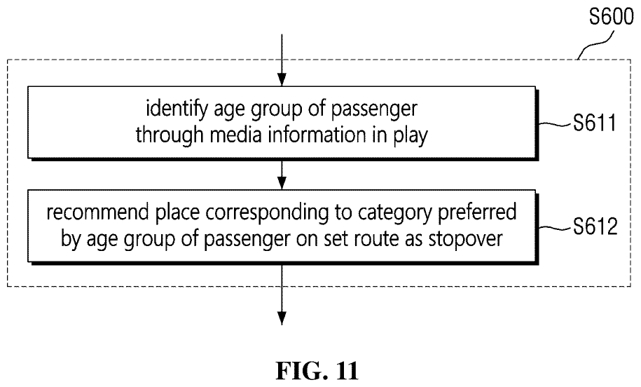

Referring to FIG. 11, in step S611, an age group of a passenger may be identified through media information in play. For example, it may be determined that a child rides in a vehicle when a children's song is being played, and it may be determined that an elderly person rides in a vehicle when a trot is being played. In step S612, a place corresponding to a category preferred by the age group of the passenger on the set route may be recommended as a stopover.

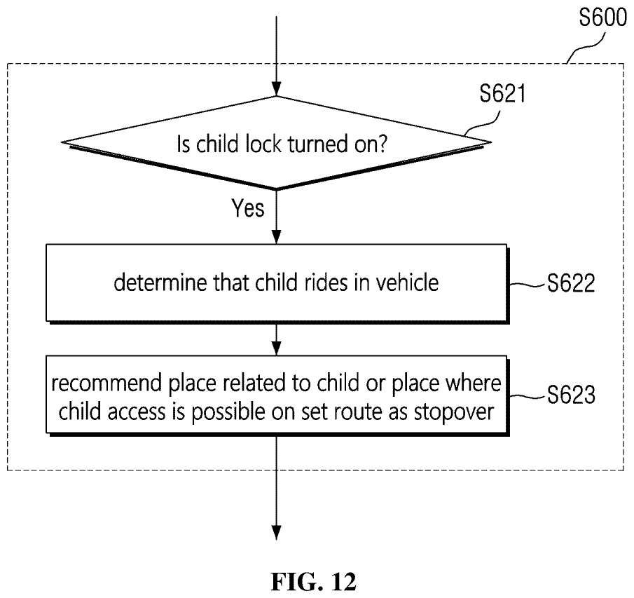

Referring to FIG. 12, in step S621, it may be determined whether a child lock is turned on. When the child lock is turned on (YES), in step S622, it may be determined that a child rides in the vehicle. Afterwards, in step S623, a place related to a child or a place where child access is possible on the set route may be recommended as a stopover.

That is, in all embodiments of FIGS. 11 and 12 described above, characteristics of the recommended stopover may be determined depending on the age group of the passenger. For example, when it is determined that a child rides in the vehicle, a stopover related to the child (e.g., a rest area with a playground, a kids cafe, an infant facility, etc.) may be recommended, and when it is determined that an elderly person rides in the vehicle, a stopover having a space to sit and rest may be recommended.

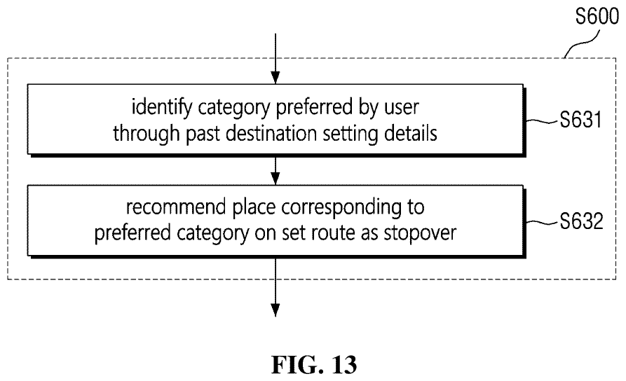

Referring to FIG. 13, in step S631, a category preferred by a user may be identified through past destination setting details. Thereafter, in step S632, a place corresponding to a preferred category on the set route may be recommended as a stopover. For example, when there is a coastal road in the past destination setting details, the coastal road passing through the set route may be recommended as a stopover, and when there is a national park in the past destination setting details, a national park existing on the set route may be recommended as a stopover.

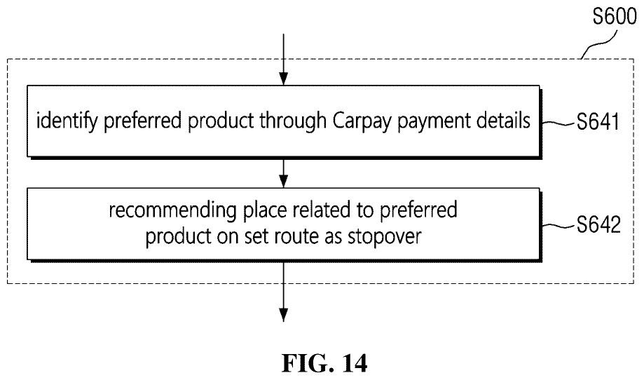

Referring to FIG. 14, in step S641, a preferred product may be identified through Carpay payment details. Afterwards, in step S642, a place (e.g., a place for selling a preferred product, a place for displaying a preferred product, etc.) related to a preferred product on the set route may be recommended as a stopover.

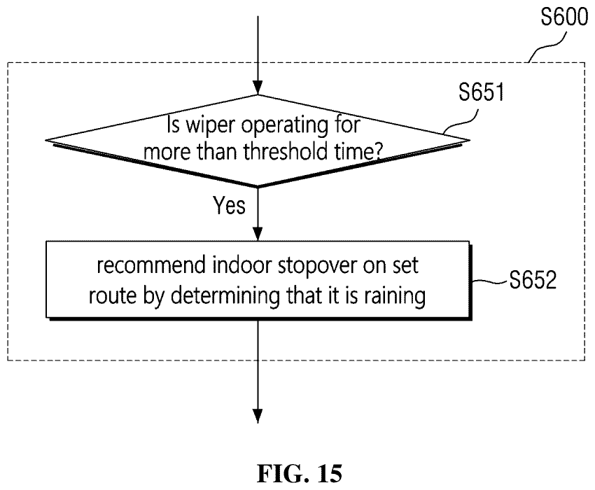

Referring to FIG. 15, in step S651, it may be determined whether a wiper is operating for a predetermined threshold time or longer. When the wiper is operating for a predetermined threshold time or more (YES), it may be considered that the wiper is continuously operating because it rains. In this case, in step S652, an indoor stopover may be recommended on the set route, and an outdoor stopover may be excluded from a recommendation target. For example, when passing through a parking spot, when it is determined that it rains, an indoor parking lot may be recommended rather than an outdoor parking lot. Through the embodiment of FIG. 15, it may be determined whether it rains through information that may be acquired in the vehicle (i.e., information as to whether the wiper operates).

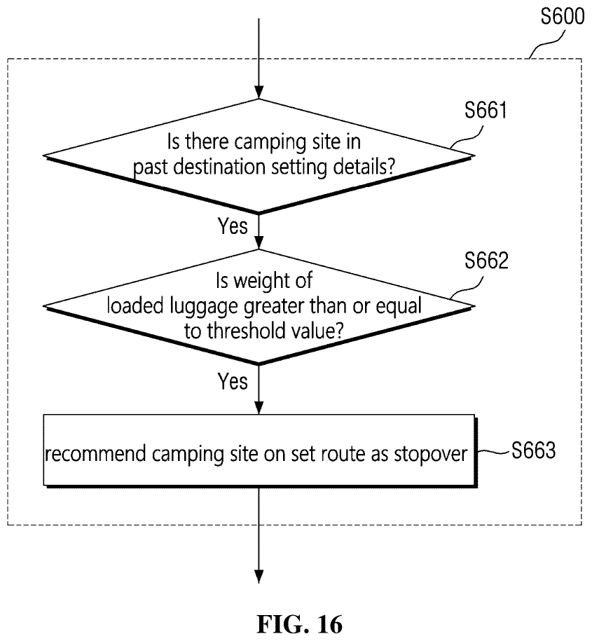

Referring to FIG. 16, in step S661, it may be determined whether there is a camping site in the past destination setting details. When there is a camping site (YES), information as to that the passenger is a camping person may be first acquired. In this case, in step S662, it may be determined whether a weight of a luggage currently loaded on the vehicle is greater than or equal to a predetermined threshold value. For example, the threshold value may be set to an average weight of camping equipment. When the weight of the loaded luggage is greater than or equal to the threshold value (YES), in step S663, the camping site on the set route may be recommended as a stopover. Although the embodiment of FIG. 16 has been described using camping as an example, the present disclosure is not limited thereto, and the weight of the loaded luggage may be used to identify other information related to the passenger and recommend an appropriate stopover correspondingly.

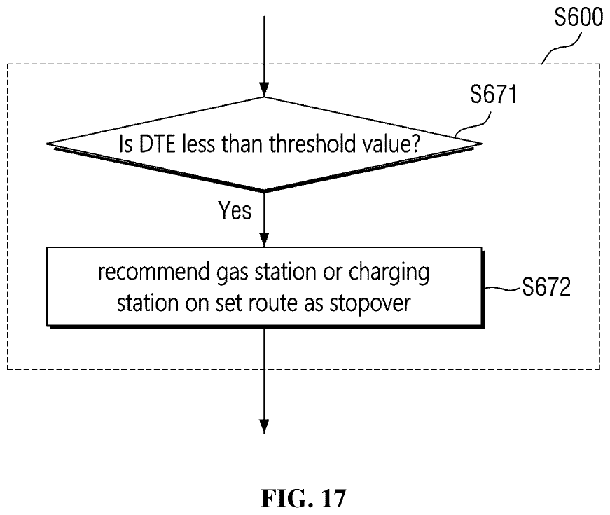

Referring to FIG. 17, in step S671, it may be determined whether a distance to empty (DTE) is less than a predetermined threshold value. For example, the threshold value may be determined based on the amount of fuel required to drive the daily driving distance. When the DTE is less than the threshold value (YES), it is determined that fueling or charging is required, so that in step S672, a gas station or a charging station on the set route may be recommended as a stopover.

FIG. 18 is a block diagram illustrating a hardware configuration of a computing device 500 for recommending a road trip stopover according to the embodiment of the present disclosure.

Referring to FIG. 18, the computing device 500 may include one or more processors 510, a bus 530, a communication interface 540, a memory 520 for loading a computer program executed by the processor 510, and a storage 550 for storing the computer program 560. However, in FIG. 18, only components related to the embodiments of the present disclosure are shown. Therefore, it may be appreciated by those skilled in the art to which the present disclosure belongs that other general components may be further included in addition to the components shown in FIG. 18. That is, the computing device 500 may further include various components in addition to the components shown in FIG. 18. Also, in some cases, the computing device 500 may be configured in the form in which some of the components shown in FIG. 18 are omitted. Hereinafter, each component of the computing device 500 will be described.

The processor 510 may control the overall operation of each component of the computing device 500. The processor 510 may be configured to include at least one of a Central Processing Unit (CPU), a Micro Processor Unit (MPU), a Micro Controller Unit (MCU), a Graphic Processing Unit (GPU), or any type of processor well known in the technical field of the present disclosure. In addition, the processor 510 may perform computation on at least one application or program for executing an operation/method according to the embodiments of the present disclosure. The computing device 500 may include one or more processors.

Next, the memory 520 may store various types of data, commands, and/or information. The memory 520 may load the computer program 560 from the storage 550 to execute the operation/method according to the embodiments of the present disclosure. The memory 520 may be implemented as a volatile memory such as RAM, but the present disclosure is not limited thereto.

Next, the bus 530 may provide a communication function between the components of the computing device 500. The bus 530 may be implemented as various types of buses such as an address bus, a data bus, and a control bus.

Next, the communication interface 540 may support wired/wireless Internet communication of the computing device 500. Also, the communication interface 540 may support various communication methods other than Internet communication. To this end, the communication interface 540 may be configured to include a communication module well known in the technical field of the present disclosure.

Next, the storage 550 may non-temporarily store one or more computer programs 560. The storage 550 may include a nonvolatile memory such as a Read Only Memory (ROM), an Erasable Programmable ROM (EPROM), an Electrically Erasable Programmable ROM (EEPROM) and a flash memory, a hard disk, a detachable disk, or any type of computer-readable recording medium well known in the art to which the present disclosure pertains.

Next, the computer program 560 may include one or more instructions that allow the processor 510 to perform the operation/method according to various embodiments of the present disclosure when loaded into the memory 520. That is, the processor 510 may perform the operation/method according to various embodiments of the present disclosure by executing the one or more loaded instructions.

For example, the computer program 560 may include instructions to calculate the time required to reach a destination set by a user, propose a road trip mode to the user based on the calculated time, vehicle information indicating a state of a vehicle, and external information when the required time exceeds a threshold time, set a route based on the vehicle information and the external information when the user decides to switch to a road trip mode, recommend a stopover on the set route based on the vehicle information and the external information, display detailed information on the set route and the recommended stopover, and determine a route including the stopover recommended as a final route in response to the user's approval.

According to the embodiment of the present disclosure, as a route suitable for characteristics of vehicle passengers is set and a stopover is recommended during a road trip in an area where driving for more than one day is performed, it is possible to provide a pleasant travel experience and a navigation system use experience. In particular, as a route and a stopover are provided in accordance with a driving pattern of the user, a safer driving experience may be provided, and help in making a plan during a road trip may be given. Furthermore, various kinds of vehicle information that may be acquired only in a vehicle may be used, so that it may be possible to set a more advanced route and recommend a stopover in a road trip situation than a mobile navigation system.

Various embodiments and the effects thereof according to the present disclosure have been mentioned with reference to FIGS. 1 through 18. The effects according to the technical spirit of the present disclosure are not limited to those mentioned above, and other effects not mentioned will be clearly understood by one of ordinary skill in the art from the description below.

While all components comprising the embodiments of the present disclosure have been described as being combined or operating in conjunction, it should not be understood that the present disclosure is limited to such embodiments. That is, within the scope of the objectives of the present disclosure, all such components can selectively be combined and operate in one or more configurations.

Although operations are illustrated in a specific order in the drawings, it should not be understood that the operations must be performed in that specific order or sequentially, or that all the illustrated operations are required to achieve desired results. In certain circumstances, multitasking and parallel processing may be advantageous. Furthermore, the separation of various components in the described embodiments should not be understood as necessary, and the described program components and systems can generally be integrated into a single software product or packaged into multiple software products.

While the embodiments of the present disclosure have been described with reference to the attached drawings, it will be understood by one skilled in the art that the present disclosure can be implemented in other specific forms without departing from the technical spirit or essential characteristics thereof. Therefore, the described embodiments should be considered in all respects as illustrative and not restrictive. The scope of the present disclosure is to be interpreted by the following claims, and all technical spirits within the equivalent scope are to be interpreted as included within the rights of the present disclosure.

What is claimed is:

1. A computing device comprising:
a processor; and
a memory storing instructions,
wherein the instructions, when executed by the processor, cause the processor to perform calculating a time required to reach a destination set by a user;
determining whether the time exceeds a threshold time, wherein the threshold time is an average of longest daily driving times from driving records of a plurality of users stored in an external server;
proposing a road trip mode based on the time required to reach the destination, a vehicle information indicating a state of a vehicle, a traffic information and a weather information when the time exceeds the threshold time;
setting a route based on the vehicle information, the traffic information and the weather information when the user decides to switch to the road trip mode;
recommending a stopover on the set route based on the vehicle information, the traffic information and the weather information;
displaying a detailed information on the set route and the stopover; and
determining a route including the stopover as a final route in response to an approval of the user on the stopover.

2. The computing device of claim 1, wherein the vehicle information includes a vehicle position (GPS) information, an information on whether a child lock is activated, an information on whether a seat belt is fastened, a media information in play, a Carpay payment details, a distance to empty (DTE) information indicating a fuel charge amount, an information on whether a wiper is operated, a load weight, or past destination setting details.

3. The computing device of claim 1, wherein the traffic information includes an information on an accident and control sections, an assembly and event information, and wherein the traffic information and the weather information are acquired from the external server.

4. The computing device of claim 1, wherein the setting the set route includes:
determining whether a child lock is turned on;
determining that a child rides in the vehicle when the child lock is turned on; and
setting the route so that a daily driving distance is less than a threshold distance, wherein the threshold distance is a maximum driving distance allowed with the child present in the vehicle.

5. The computing device of claim 1, wherein the setting the set route includes:
acquiring an average daily driving time and a maximum driving time without a stop from the driving records; and
setting the set route so that a total driving time does not exceed the average daily driving time and the stopover is located within the maximum driving time.

6. The computing device of claim 1, wherein the setting the set route includes:
determining a section, which is not to be driven, based on the traffic information or the weather information; and
setting the set route by excluding the section.

7. The computing device of claim 1, wherein the setting the set route includes:
acquiring driving routes of other users with a same driving pattern or a same type of passenger as the user; and
setting the set route to one of the driving routes of the other users.

8. The computing device of claim 1, wherein the recommending the stopover on the set route includes:
determining whether seatbelts in seats other than a driver's seat of the vehicle are fastened;
identifying a number of passengers through a number of the seatbelts fastened when the seatbelts in the seats other than the driver's seat are fastened; and
recommending a place, which is to be used by the number of passengers on the set route, as the stopover.

9. The computing device of claim 1, wherein the recommending the stopover on the set route includes:
identifying an age group of a passenger through a media information in play in the vehicle; and
recommending a place corresponding to a category preferred by the age group of the passenger as the stopover on the set route.

10. The computing device of claim 1, wherein the recommending the stopover on the set route includes:
determining whether a child lock is turned on;
determining that a child rides in the vehicle when the child lock is turned on; and
recommending a place related to a child or a place where child access is possible on the set route as the stopover.

11. The computing device of claim 1, wherein the recommending the stopover on the set route includes:
identifying a category preferred by the user through past destination setting details; and
recommending a place corresponding to the category on the set route as the stopover.

12. The computing device of claim 1, wherein the recommending the stopover on the set route includes:
identifying a product preferred by the user through a Carpay payment details; and
recommending a place related to the product on the set route as the stopover.

13. The computing device of claim 1, wherein the recommending the stopover on the set route includes:
determining whether a wiper is operating for more than a threshold time; and
recommending an indoor stopover on the set route by determining that it is raining when the wiper is operating for more than the predetermined threshold time.

14. The computing device of claim 1, wherein the recommending the stopover on the set route includes:
determining whether there is a camping site in past destination setting details of the user;
determining whether a weight of luggage loaded in the vehicle is greater than or equal to a predetermined threshold value when there is a camping site in the past destination setting details; and
recommending the camping site on the set route as the stopover when the weight of the luggage is greater than or equal to the predetermined threshold value.

15. The computing device of claim 1, wherein the recommending the stopover on the set route includes:
determining whether a distance to empty (DTE) is less than a predetermined threshold value, wherein the threshold value is determined based on an amount of fuel required to drive a daily driving distance; and
recommending a gas station or a charging station on the set route as the stopover when the DTE is less than the predetermined threshold value.

16. A road trip stopover recommendation method, which is performed by a computing device, the road trip stopover recommendation method comprising:
calculating a time required to reach a destination set by a user;
determining whether the time exceeds a threshold time, wherein the threshold time is an average of longest daily driving times among driving records of a plurality of users stored in an external server;
proposing a road trip mode based on the time required to reach the destination, a vehicle information indicating a state of a vehicle, a traffic information and a weather information when the time exceeds the threshold time;
setting a route based on the vehicle information, the traffic information and the weather information when the user decides to switch to the road trip mode;
recommending a stopover on the set route based on the vehicle information, the traffic information and the weather information;
displaying a detailed information on the set route and the stopover; and
determining a route including the stopover as a final route in response to an approval of the user on the stopover.

17. The road trip stopover recommendation method of claim 16, wherein the vehicle information includes a vehicle position (GPS) information, an information on whether a child lock is activated, an information on whether a seat belt is fastened, a media information in play, a Carpay payment details, a distance to empty (DTE) information indicating a fuel charge amount, an information on whether a wiper is operated, a load weight, or past destination setting details.

18. The road trip stopover recommendation method of claim 17, wherein the setting the set route includes:
acquiring an average daily driving time and a maximum driving time without a stop from the driving records; and
setting the set route so that a total driving time does not exceed the average daily driving time and the stopover is located within the maximum driving time.

19. The road trip stopover recommendation method of claim 17, wherein the recommending the stopover on the set route includes:
determining whether seatbelts in seats other than a driver's seat of the vehicle are fastened;
identifying a number of passengers through a number of the seatbelts fastened when the seatbelts in the seats other than the driver's seat are fastened; and
recommending a place, which is to be used by the number of passengers on the set route, as the stopover.

20. The road trip stopover recommendation method of claim 17, wherein the recommending the stopover on the set route includes:
determining whether a child lock is turned on;
determining that a child rides in the vehicle when the child lock is turned on; and
recommending a place related to a child or a place where child access is possible on the set route as the stopover.
